(19) United States
(12) Patent Application Publication
(10) Pub. No.: US 2023/0419220 A1
(43) Pub. Date: Dec. 28, 2023

(54) CHANGE LOG PROCESSING FOR CHAINED WORKFLOWS

(71) Applicant: Raven Industries, Inc., Sioux Falls, SD (US)

(72) Inventor: Kyle John Sonaty, Westville, IN (US)

(73) Assignee: Raven Industries, Inc., Sioux Falls, SD (US)

(21) Appl. No.: 18/343,560

(22) Filed: Jun. 28, 2023

Related U.S. Application Data
(60) Provisional application No. 63/367,202, filed on Jun. 28, 2022.

(51) Int. Cl. G06Q 10/0633; G06F 9/54

(52) U.S. Cl. CPC G06Q 10/0633; G06F 9/543; G06Q 50/02

(57) ABSTRACT

A computer-implemented method may include receiving, over an API, a command identifying a change in an agricultural task; converting, using a processing unit, the command into an event; based on an event type of the event, retrieving a subset of workflows from a workflow datastore; electronically evaluating conditional expressions in the subset of workflows using data of the event; and based on the evaluating, determining a conditional expression of a workflow of the subset of workflows evaluates to true; and in response to the determining, electronically issuing a command using the API in accordance with an action of the workflow of the subset of workflows.

### CROSS-RELATED TO RELATED APPLICATIONS

This application claims the benefit of priority to U.S. Provisional Patent Application Ser. No. 63/367,202, filed Jun. 28, 2022, titled CHANGE LOG PROCESSING FOR CHAINED WORKFLOWS, herein incorporated by reference in its entirety.

### BACKGROUND

Modern agricultural equipment (e.g., combines, tractors, etc.) includes many sensors that permit them to perform semi or fully autonomously if assigned a task. For example, an agricultural task may be used to fertilize a particular field according to a particular path. To this end, a server-based dispatch program may create the agricultural task and assign it to the piece of agricultural equipment via an application programming interface. Upon completing the task, the agricultural equipment may transmit a message back to the server-based dispatch program.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a workflow creation interface, according to various examples.

FIG. 3 is a condition builder user interface, according to various examples.

FIG. 4 is a field operation interface, according to various examples.

FIG. 5 is a stored workflow interface, according to various examples.

FIG. 6 is a flowchart illustrating a method of executing a workflow, according to various examples.

FIG. 7 is a flowchart illustrating a method of executing a workflow, according to various examples.

FIG. 8 is a block diagram illustrating a machine in the example form of computer system, within which a set or sequence of instructions may be executed to cause the machine to perform any one of the methodologies discussed herein, according to various examples.

### DETAILED DESCRIPTION

In the following description, for purposes of explanation, numerous specific details are set forth to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not infer either one of these options.

Additionally, the elements and portions are sometimes described as being configured for a certain purpose. For example, an input element may be described as configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database

One of the problems with server-based dispatch systems for agricultural tasks is that each user of the system may have different preferences for what should happen in response to certain events. For example, an electronic message may be received that indicates an agricultural task was completed, but this may not always mean that the agricultural task was completed successfully. For example, consider the task is to fertilize a particular field. A completion message may include values of parameters associated with the task such as what portion of the field was successfully fertilized. Without manually checking the parameters, the user may not even know that the task was not completed successfully. Furthermore, unsuccessful may mean something different to each user.

To improve upon electronic dispatch systems for agricultural tasks, systems and methods are described herein for creation and automatic performance of user (e.g., an individual or organization) specific workflows. User interfaces are provided to define a workflow based on a data model, an event type, a conditional expression, and an action to take if the conditional expression evaluates to true. An event log may be automatically monitored and workflows that are implicated (e.g., use the event type) by the event may be retrieved to have their conditional expressions evaluated. If the conditional expression evaluates to true, the defined action may be performed, which in turn creates another command that is customized to the user with automatic performance of actions. In this manner, workflows may be chained. One benefit of this is to quickly remediate problems that otherwise may not have been fixed in time or lead to a cascade of delays in other tasks. For example, if a field was not successfully fertilized a workflow may be created to automatically create another task to finish the task. together.

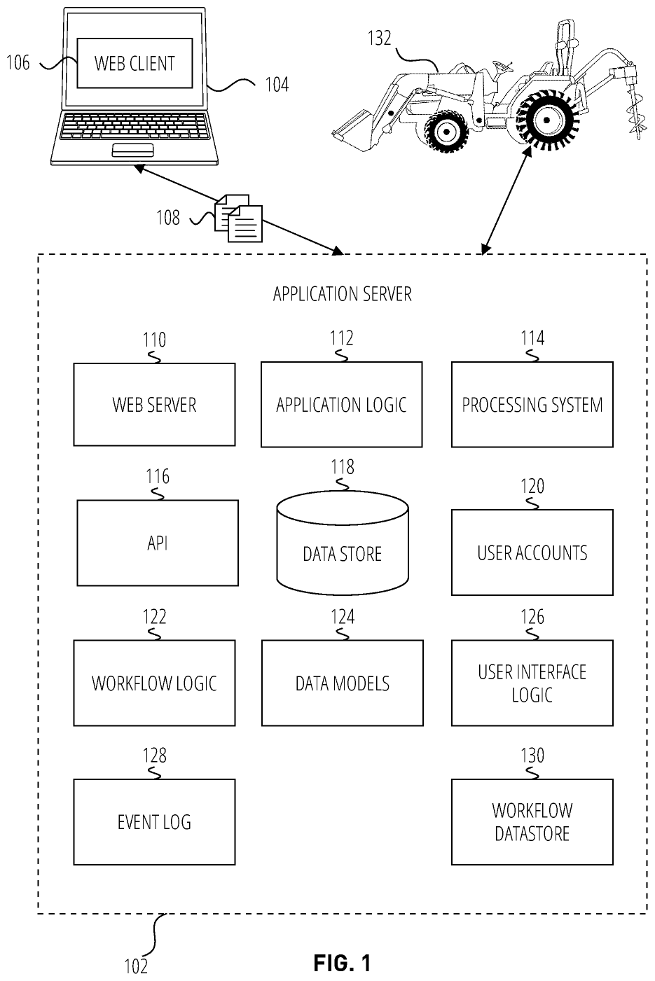

FIG. 1 is an illustration of components of a client device and an application server, according to various examples. FIG. 1 includes an application server 102, a client device 104, a web client 106, a data 108, a web server 110, application logic 112, a processing system 114, an API 116, a data store 118, user accounts 120, workflow logic 122, data models 124, user interface logic 126, an event log 128, a workflow datastore 130, and a tractor 132.

Application server 102 is illustrated as set of separate components; however, the functionality of multiple, individual components may be performed by a single component. A component may represent computer program code that is executable by processing system 114. The program code may be stored on a storage device (e.g., data store 118) and loaded into a memory of the processing system 114 for execution. Portions of the program code may be executed in a parallel across multiple processing units (e.g., a core of a general-purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 may be a computing device which may be, but is not limited to, a smartphone, tablet, laptop, multi-processor system, microprocessor-based or programmable consumer electronics, game console, set-top box, or another device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

Client device 104 and application server 102 may communicate data 108 over the network. Data 108 may include a data package that includes parameters for a workflow data structure. For example, client device 104 may present a series of user interface elements for creating a workflow described in more detail herein. Data 108 may also include presentation of information related to an agricultural task. Thus, for an assigned task, a user may view parameters about the tasks such as whether it was completed, when it was completed, and more detailed parameters such as how much of the field was successfully serviced, etc.

In some examples, the communication may occur using an application programming interface (API) such as API 116. An API provides a method for computing processes to exchange data. A web-based API (e.g., API 116) may permit communications between two or more computing devices such as a client (e.g., client device 104 or a computer on tractor 132) and a server. The API may define a set of HTTP calls according to Representational State Transfer (RESTful) practices. For examples, A RESTful API may define various GET, PUT, POST, DELETE methods to create, replace, update, and delete data stored in a database (e.g., data store 118).

API 116 may include calls for assigning tasks to a piece of agricultural equipment/field, receiving an update on a task from agricultural equipment, creation of a workflow, retrieving workflows from a workflow data store, among others. An API call may include a payload (in a JavaScript Object Notion format) that includes a user identifier, organization identifier, equipment identifier, field identifier, etc.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications provided in a transmitted web page. A web application may provide user interface (UI) components that are rendered on a display device of client device 104. The user may interact (e.g., select, move, enter text into) with the UI components, and based on the interaction, the web application may update one or more portions of the web page. A web application may be executed in whole, or in part, locally on client device 104. The web application may populate the UI components with data from external sources or internal sources (e.g., data store 118) in various examples. In various examples, the web application is configured to allow for the creation and modification of workflows with respect to the different data models 124. A more detailed discussion of the user interface is discussed with respect to other elements and figures herein.

The web application may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the web server 110. Application logic 112 may use other elements (user accounts 120, workflow logic 122, data models 124, user interface logic 126, event log 128, and workflow datastore 130) of application server 102 to perform functionality associated with the web application as described further herein.

Data store 118 may store data that is used by application server 102. Data store 118 is depicted as singular element but may in actuality be multiple data stores. The specific storage layout and model used in by data store 118 may take a number of forms—indeed, a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be located in one or more geographic areas. Additionally, although workflow datastore 130 is depicted as a separate element of application server 102, it may be part of data store 118, in various examples.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples. A user account may be associated with an organizational identifier (e.g., a company name or domain such as acme.com). Associated may mean that within a datastore there is a link between the organizational identifier and a username—e.g., a table may have a column for usernames and organizational identifiers. Accordingly, different users may have different workflows. As part of a workflow data structure, the organizational identifier may be stored with (e.g., linked by a relation in a database) the workflow, in various examples.

Upon logging into application server 102, a user may be presented with the web application to create or modify workflows. Existing workflows associated with the user may be presented. To obtain the user's workflows, application server 102 may query workflow datastore 130 using the organizational identifier of the user.

The functions and use of workflow logic 122, data models 124, user interface logic 126, event log 128, and workflow datastore 130 are discussed further in the context of the following figures.

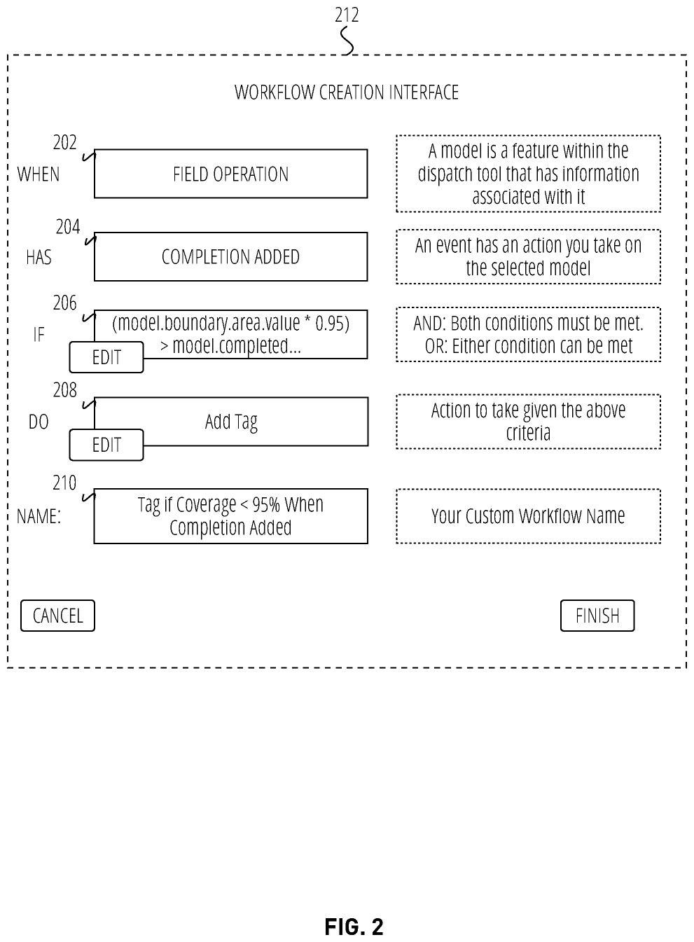

FIG. 2 is a workflow creation interface, according to various examples. FIG. 2 includes a model selection 202, an event type selection 204, a conditional expression field 206, an action field 208, a name field 210, and a workflow creation interface 212. Workflow creation interface 212 may be presented in response to application server 102 receiving an indication that a user wants to create a new workflow, such as by the user activating (e.g., clicking) a user interface element presented on a web page. The arrangement and labels of the elements of workflow creation interface 212 are examples, and others may be used without departing from the scope of this disclosure.

Model selection 202 may be a dropdown menu configured to receive a selection of a data model. Different data models may be stored in data models 124. A data model may conform to a schema and be associated with a feature of application server 102. For example, field operations, as displayed in model selection 202, may be one data model. Other data models may include batching, equipment, and shipments.

A data model in data models 124 may include a schema (e.g., defined in a structured language such as extensible markup language (XML) or as part of a programming class object). The data model may define event types with respect to the model. Furthermore, each event type may include parameters associated with the event type. The parameters may be used in the conditional expression field 206 or as part of the action.

User interface logic may be used to update the fields of FIG. 2 based on selections of other fields. For example, upon a user selecting a model in model selection 202, a drop-down menu of event type selection 204 may be populated with the event types for the model—in this case, field operations. The event type in event type selection 204 is a “competition added event. Other field operation event types may be created, released, completion updated, or completion deleted.

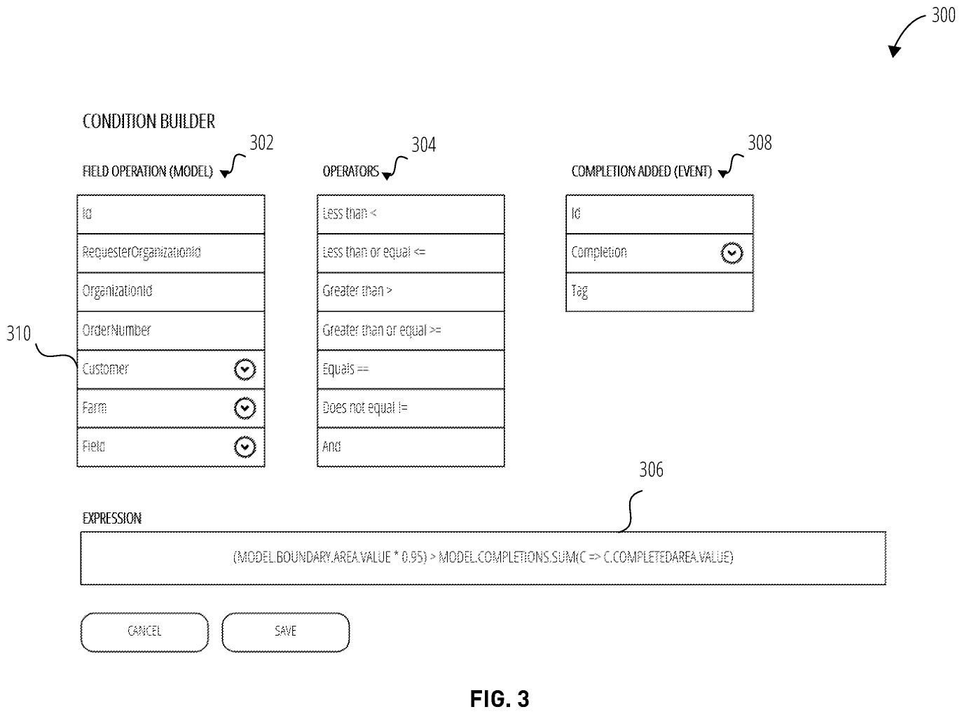

Condition expression field 206 may be used to identify a conditional expression for the event type of the model. Boolean logic may be used to generate a Bool statement that evaluates to True or False. In the example of FIG. 2, a model parameter of the boundary area of a field is compared against the actual completed area of the field as determined by an event type parameter. A separate interface may be used to help generate the conditional expressions in various examples (see FIG. 3).

The items in drop-down menu of action field 208 may be based on the selection of an event type or model, in various examples. With respect to the FIG. 2 example, an “add tag” action is selected. Other actions may include release, remove assignments, and insert assignments. If a user selects the edit button of action field 208, a further input element may be presented for detailing the action in more detail based on the selection in action field 208. For example, in the context of the “add tag” action, the edit button may request a label to use for the tag such as “partial.”

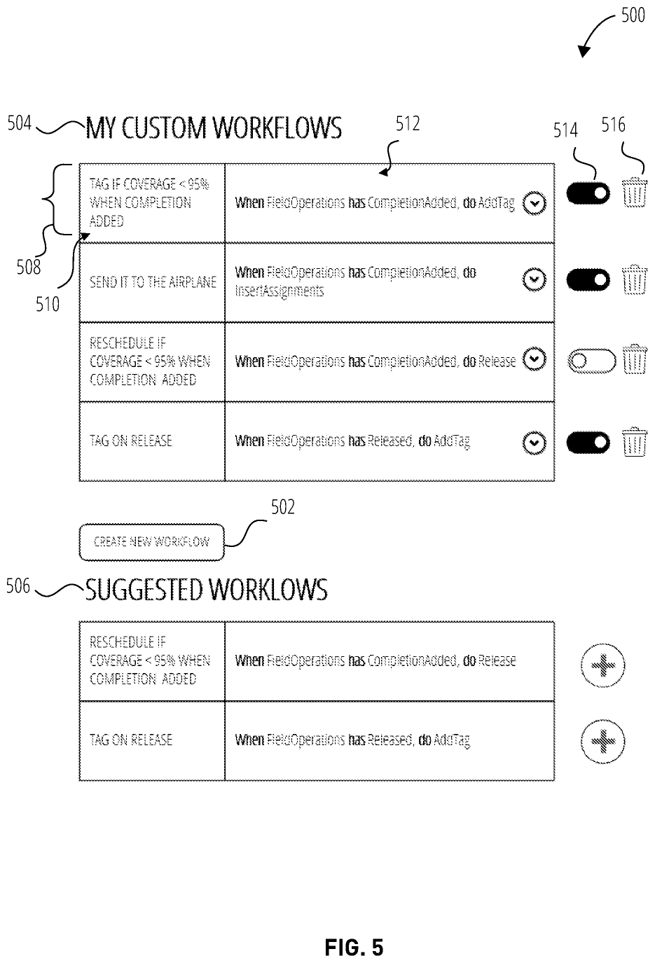

Name field 210 may be used by the user to create a label for the workflow. These workflows may be edited using a separate interface (e.g., as depicted in FIG. 5). When a user is done creating a workflow, they may select the finish button of workflow creation interface 212 to have the workflow saved as a workflow data structure in workflow datastore 130. In addition to the information depicted in workflow creation interface 212, the workflow data structure may include an organizational identifier for the workflow based on the user creating the workflow.

FIG. 3 is a condition builder user interface 300, according to various examples. FIG. 3 includes model parameter selector 302, operator parameter selector 304, conditional expression 306, event parameter selector 308, and parameter 310. The condition builder user interface may be presented in response to a user selecting the edit field of conditional expression field 206.

The parameters that are presented in model parameter selector 302 may be based on the model that was selected in model selection 202. For example, model parameter selector 302 presents parameters according to the field operations schema. When a user selects a parameter (e.g., clicks a parameter in model parameter selector 302) it may be placed at the location of a text cursor in conditional expression 306. In this manner, a user may not be required to remember all the possible value parameter types for each model. Similarly, the parameters displayed in event parameter selector 308 may be based on event type selection 204. The use of user interface 300 reduces the possibility of errors that may be introduced by a user entering in a parameter that does not exist (or has a typo) for a given model or event.

As illustrated, some of the parameters have drop-down menus themselves. For example, the down arrow at the end of parameter 310 may be selected, and in response, sub-elements of a customer parameter may be presented. For example, there may be an “ID” and “name” element. If a user selects “name” application server 102 may place the full string of “model.customer.name” into conditional expression 306 as opposed to “name.”

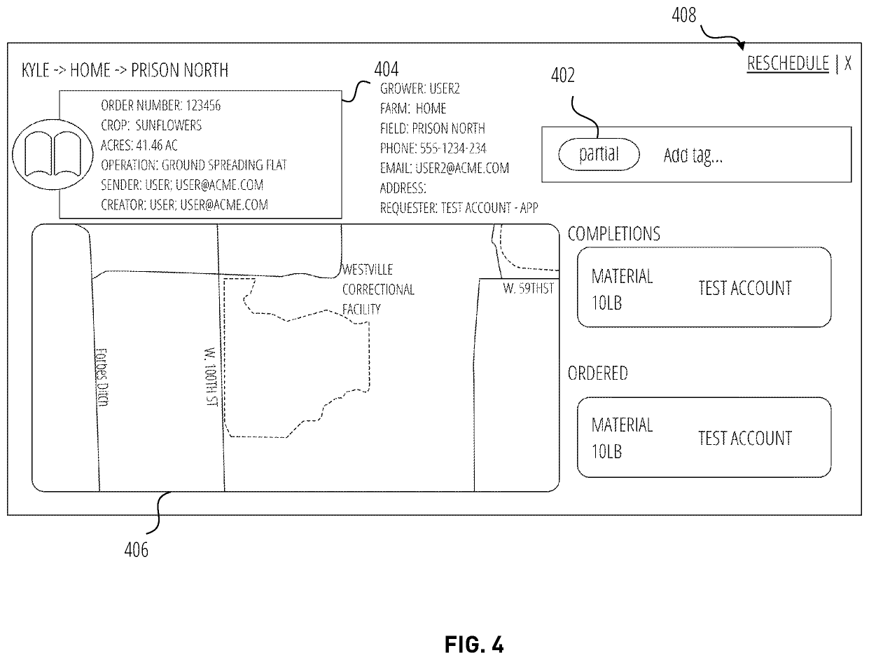

FIG. 4 is a field operation interface, according to various examples. An interface such as presented in FIG. 4 may be used by users to view information on specific field operations. For example, field overview 404 shows that the crop was sunflowers, and the operation was “ground spreading flat.” Map 406 illustrates a geographic area and an outline of the “prison north” field of the “home” farm.

Consider that this field operation had a completed value of less than 95%. Accordingly, the conditional expression of FIG. 2 would evaluate to “True”, and a tag would be added (e.g., an entry in data store 118 may be updated). In this case, the tag is presented as tag 402. There is also an option presented to reschedule the operation (e.g., reschedule element 408).

The interface presented in FIG. 4 may extend (not shown) to include a vertical timeline of events with respect to the field. For example, there may be “assignment added” event, a “completion” event, and a “tag added” event. The “tag added” event may also include an indication that the tag “partial” added is the result of a custom workflow and identify the custom workflow's name. The use of a tag may be used by a user to find all the field operations that were not complete according to the workflow. For example, a search interface (not shown) may be used to generate a query to find all operations that have or do not have a particular tag.

FIG. 5 is a stored workflow interface 500, according to various examples. FIG. 5 includes create workflow element 502, stored workflows 504, suggested workflows 506, workflow entry 508, workflow rules 512, and workflow identifier 510.

The workflows included in stored workflows 504 may be based on a query issued to workflow datastore 130 using an identifier (e.g., an organization identifier) of a user. For example, a user may log in to application server 102 and be presented with an interface such as stored workflow interface 500 based on the results of the query. Workflow entry 508 includes a workflow identifier 510 and workflow rules 512. Workflow rules 512 may be a summarized version of the criteria for the workflow as created by a user using an interface such as workflow creation interface 212.

Controls such as a toggle to turn on or off the workflow (e.g., toggle 514) and a delete control (e.g., delete rule element 516) may also be presented. A user may create a new workflow using create workflow element 502 to have an interface such as workflow creation interface 212 be presented. Additionally, suggested workflows 506 may be used by a user to create workflows more quickly. Suggested workflows 506 may be based on frequently created workflows, in various examples.

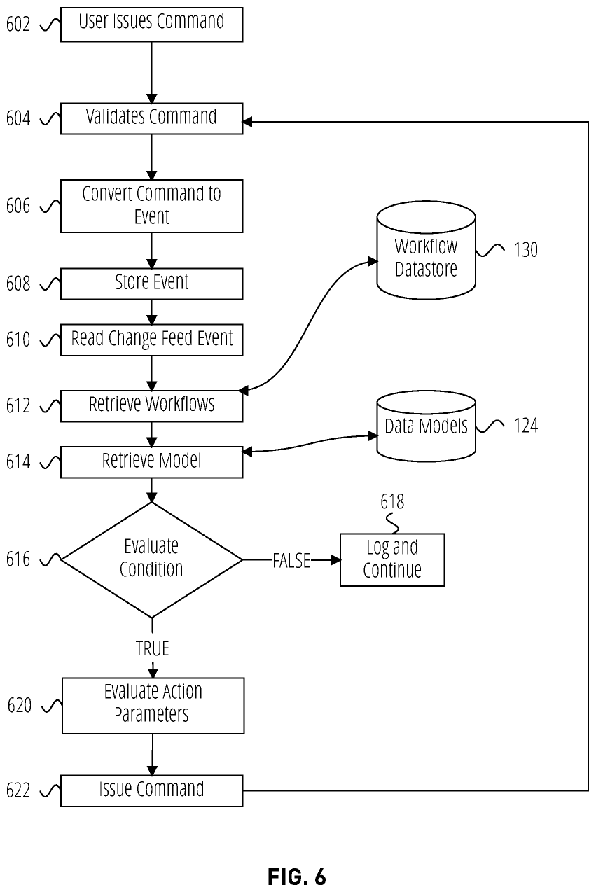

FIG. 6 is a flowchart illustrating a method of executing a workflow, according to various examples. The method is represented as a set of blocks that describe operations of the method. The operations may be part of workflow logic 122. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 6. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At block 602, a user (or device) may issue a command to change data on application server 102 via API 116 executing on web client 106. For example, a user may be using web client 106 on client device 104. The command may be a user assigning a task to a piece of equipment, generating a new shipment order, rescheduling a field operation, etc.

At block 604, the change data may be validated. For example, validating may include checking that parameters of the command are within accepted values, data integrity checks, checking if all needed values are included in the command, etc. At block 606, if the command is successfully validated, it may be converted to an event. Converting may include creating an event data structure that includes an event type and parameter values of the event type.

At block 608, the event may be stored in event log 128 as a log entry. A process of application server 102 may be notified when a new event is added to the event log 128. Upon receiving the notification (or as part of a periodic checking of the log), the event may be read from the event log at block 610.

At block 612, workflows associated with the event type/model may be retrieved from workflow datastore 130. To limit the amount of processing time, only those workflows (e.g., a subset of all the workflows for every user) associated with the organizational identifier of the user associated with the event are retrieved. Furthermore, in various examples, only those workflows that have the event type of the event may be retrieved.

At block 614, the method retrieves the latest version of the model from data models 124 and passes the model and event data to decision block 616 for evaluating the conditional expressions of the retrieved workflows. The condition expression is then evaluated using the model and event. If the condition succeeds (e.g., is True), the action is invoked. For example, at block 620 the action is passed the same model and event, and for each parameter of the action, an expression is evaluated to fill in the data needed to execute the action. At block 622 the action is executed which then issues a command to change the system, and flow returns to block 604. If at decision block 616 a conditional expression is False, then at block 618 the event is logged with no action taken.

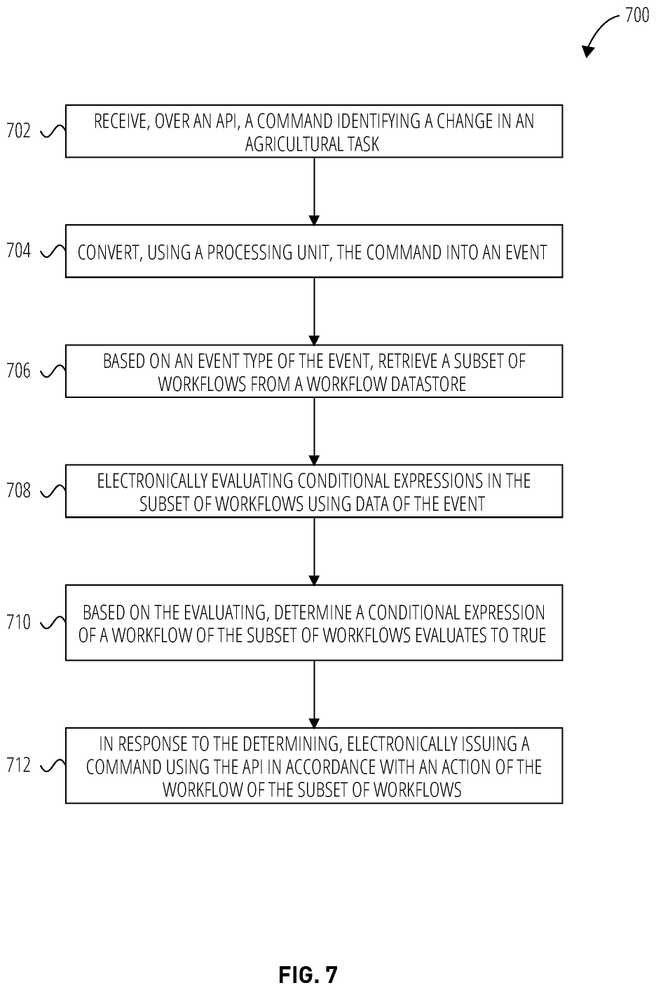

FIG. 7 is a flowchart illustrating a method of executing a workflow, according to various examples. The method is represented as a set of blocks of routine 700 that describe operations of the method. The operations may be part of workflow logic 122. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, the API may be API 116 and the command may originate from a computing device such as may be installed on tractor 132 or a sensor in a field or the API command may be based on a user using client device 104. Application server 102 may then proceed to processing the data included in the API command.

In various examples, the method includes converting, using a processing unit, the command into an event at block 704. Converting may include transforming the data from the API command into an event format. For example, a lookup table may be used to determine an event type based on the change from block 702. Other information included in the event data structure may be a user identifier and organization identifier.

In various examples, the method includes, based on an event type of the event, retrieving a subset of workflows from a workflow datastore at block 706. In various examples, the event type is defined as part of a data model of a set of data models. The set of data models may be data models 124. For example, the data model may be a field operation data model for the agricultural task. The event type may be a completion event.

Furthermore, instead of retrieving all workflows from a workflow datastore, the subset may just be those that have the event type. Accordingly, retrieving the subset may include generating a query using the data model and event type as filter parameters and the workflow datastore as a target of the query. Then the query may be executed. Routine 700 may include receiving identifications of the subset of workflows as a result of executing the query. In various example, the command identifying a change in an agricultural task includes the organizational identification. The organizational identification may be included as a filter parameter of the query. Consequently, the number of workflows in the subset of workflows may further be reduced.

In various examples, the method includes electronically evaluating conditional expressions in the subset of workflows using data of the event at block 708. For example, the routine may iterate through each respective workflow of the subset of workflows and evaluate the conditional expressions of the respective workflow (as may have been defined using an interface such as workflow creation interface 212).

In various examples, the method includes based on the evaluating, determining a conditional expression of a workflow of the subset of workflows evaluates to true at block 710. For example, the conditional expression may be one such as conditional expression 306.

According to some examples, the method includes in response to the determining, electronically issuing a command using the API in accordance with an action of the workflow of the subset of workflows at block 712. For example, the action defined for a workflow may be the command as defined in an interface field such as action field 208.

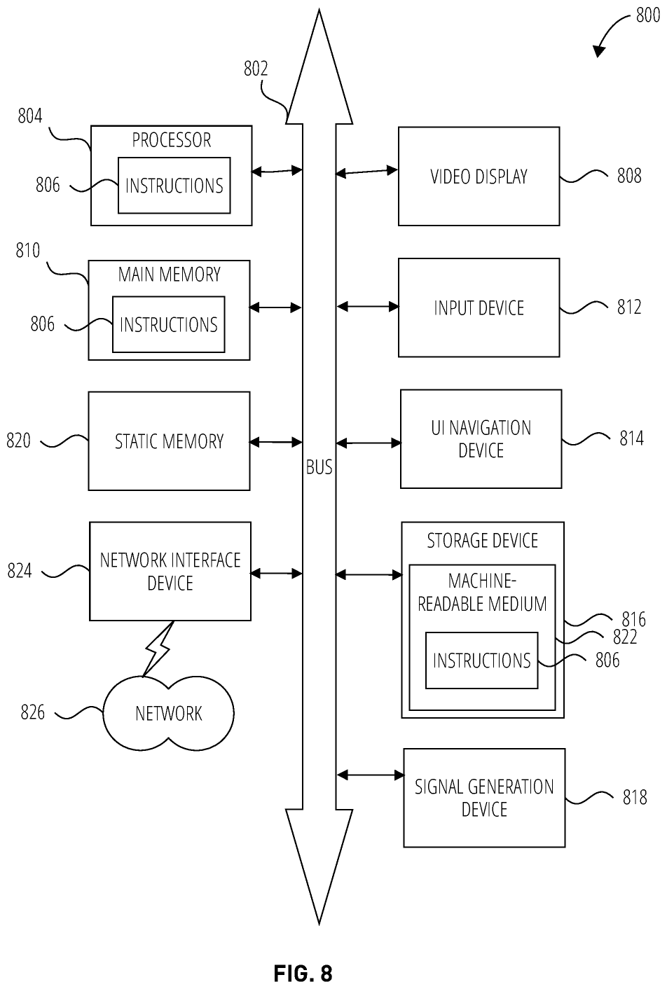

FIG. 8 is a block diagram illustrating a machine in the example form of computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 804 (e.g., a central processing unit (CPU), a graphics processing unit (GPU) or both, processor cores, compute nodes, etc.), a main memory 810 and a static memory 820, which communicate with each other via a bus 802. The computer system 800 may further include a video display 808, an input device 812 (e.g., a keyboard), and a user interface (UI) navigation device 3 (e.g., a mouse). In one embodiment, the video display 808, input device 812, and UI navigation device 814 are incorporated into a single device housing such as a touch screen display. The computer system 800 may additionally include a storage device 816 (e.g., a drive unit), a signal generation device 818 (e.g., a speaker), a network interface device 824, and one or more sensors (not shown), such as a global positioning system (GPS) sensor, compass, accelerometer, or other sensors.

The storage device 816 includes a machine-readable medium 822 on which is stored one or more sets of data structures and instructions 806 (e.g., software) embodying or utilized by any one or more of the methodologies or functions described herein. The instructions 806 may also reside, completely or at least partially, within the main memory 810, static memory 820, and/or within the processor 804 during execution thereof by the computer system 800, with the main memory 810, static memory 820, and the processor 804 also constituting machine-readable media.

While the machine-readable medium 822 is illustrated in an example embodiment to be a single medium, the term “machine-readable medium” may include a single medium or multiple media (e.g., a centralized or distributed Database, and/or associated caches and servers) that store the one or more instructions 806. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 822 that excluded transitory signals.

The instructions 806 may further be transmitted or received over a communications network 826 using a transmission medium via the network interface device 824 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Example 1 is a computer-implemented method comprising: receiving, over an API, a command identifying a change in an agricultural task; converting, using a processing unit, the command into an event; based on an event type of the event, retrieving a subset of workflows from a workflow datastore; electronically evaluating conditional expressions in the subset of workflows using data of the event; and based on the evaluating, determining a conditional expression of a workflow of the subset of workflows evaluates to true; and in response to the determining, electronically issuing a command using the API in accordance with an action of the workflow of the subset of workflows.

In Example 2, the subject matter of Example 1 optionally includes wherein the event type is defined as part of a data model of a set of data models.

In Example 3, the subject matter of Example 2 optionally includes wherein retrieving the subset of workflows from a workflow datastore includes: generating a query using the data model and event type as filter parameters and the workflow datastore as a target; executing the query; and receiving identifications of the subset of workflows as a result of executing the query.

In Example 4, the subject matter of Example 3 optionally includes wherein the data model is a field operation data model for the agricultural task.

In Example 5, the subject matter of Example 4 optionally includes the computer-implemented method Example 4, wherein the event type is a completion event.

In Example 6, the subject matter of any one or more of Examples 3-5 optionally include wherein the command identifying a change in an agricultural task includes an organizational identification and wherein the organizational identification is included as a filter parameter of the query.

In Example 7, the subject matter of any one or more of Examples 1-6 optionally include presenting a workflow creation user interface element on a client device including: a model selection user interface element configured to receive a selection of a model from a set of data models an event type selection user interface element configured to receive a selection of an event type from a set of event types for the selected data model; a conditional input element configured to receive an evaluation expression associated with a parameter of the selected event type; and an action input element configured to receive an action to perform when the evaluation expression is true; receiving a data package including an identification of the model, an identification of the event type, the evaluation expression, and the action; in response to receiving the data package, generating a workflow data structure based on the identification of the model, the identification of the event type, the evaluation expression, and the action; storing the workflow data structure in the workflow datastore.

Example 8 is a non-transitory computer-readable storage medium, the computer-readable storage medium including instructions that when executed by a processor, cause the processor to perform operations comprising: receiving, over an API, a command identifying a change in an agricultural task; converting, using a processing unit, the command into an event; based on an event type of the event, retrieving a subset of workflows from a workflow datastore; electronically evaluating conditional expressions in the subset of workflows using data of the event; and based on the evaluating, determining a conditional expression of a workflow of the subset of workflows evaluates to true; and in response to the determining, electronically issuing a command using the API in accordance with an action of the workflow of the subset of workflows.

In Example 9, the subject matter of Example 8 optionally includes wherein the event type is defined as part of a data model of a set of data models.

In Example 10, the subject matter of Example 9 optionally includes wherein retrieving the subset of workflows from a workflow datastore includes: generating a query using the data model and event type as filter parameters and the workflow datastore as a target; executing the query; and receiving identifications of the subset of workflows as a result of executing the query.

In Example 11, the subject matter of Example 10 optionally includes wherein the data model is a field operation data model for the agricultural task.

In Example 12, the subject matter of Example 11 optionally includes wherein the event type is a completion event.

In Example 13, the subject matter of any one or more of Examples 10-12 optionally include wherein the command identifying a change in an agricultural task includes an organizational identification and wherein the organizational identification is included as a filter parameter of the query.

In Example 14, the subject matter of any one or more of Examples 8-13 optionally include wherein the instructions further configure the processor to perform operations comprising: presenting a workflow creation user interface element on a client device including: a model selection user interface element configured to receive a selection of a model from a set of data models an event type selection user interface element configured to receive a selection of an event type from a set of event types for the selected data model; a conditional input element configured to receive an evaluation expression associated with a parameter of the selected event type; and an action input element configured to receive an action to perform when the evaluation expression is true; receiving a data package including an identification of the model, an identification of the event type, the evaluation expression, and the action; in response to receiving the data package, generating a workflow data structure based on the identification of the model, the identification of the event type, the evaluation expression, and the action; storing the workflow data structure in the workflow datastore.

Example 15 is a system comprising: a processor; a storage device comprising instructions, which when executed by the processor, configure the process to perform operations comprising: receiving, over an API, a command identifying a change in an agricultural task; converting, using a processing unit, the command into an event; based on an event type of the event, retrieving a subset of workflows from a workflow datastore; electronically evaluating conditional expressions in the subset of workflows using data of the event; and based on the evaluating, determining a conditional expression of a workflow of the subset of workflows evaluates to true; and in response to the determining, electronically issuing a command using the API in accordance with an action of the workflow of the subset of workflows.

In Example 16, the subject matter of Example 15 optionally includes wherein the event type is defined as part of a data model of a set of data models.

In Example 17, the subject matter of Example 16 optionally includes wherein retrieving the subset of workflows from a workflow datastore includes: generating a query using the data model and event type as filter parameters and the workflow datastore as a target; executing the query; and receiving identifications of the subset of workflows as a result of executing the query.

In Example 18, the subject matter of Example 17 optionally includes wherein the data model is a field operation data model for the agricultural task.

In Example 19, the subject matter of Example 18 optionally includes wherein the event type is a completion event.

In Example 20, the subject matter of any one or more of Examples 17-19 optionally include wherein the command identifying a change in an agricultural task includes an organizational identification and wherein the organizational identification is included as a filter parameter of the query.

What is claimed is:

1. A computer-implemented method comprising:
receiving, over an API, a command identifying a change in an agricultural task;
converting, using a processing unit, the command into an event;
based on an event type of the event, retrieving a subset of workflows from a workflow datastore;
electronically evaluating conditional expressions in the subset of workflows using data of the event; and
based on the evaluating, determining a conditional expression of a workflow of the subset of workflows evaluates to true; and
in response to the determining, electronically issuing a command using the API in accordance with an action of the workflow of the subset of workflows.

2. The computer-implemented method of claim 1, wherein the event type is defined as part of a data model of a set of data models.

3. The computer-implemented method of claim 2, wherein retrieving the subset of workflows from a workflow datastore includes:
generating a query using the data model and event type as filter parameters and the workflow datastore as a target;
executing the query; and
receiving identifications of the subset of workflows as a result of executing the query.

4. The computer-implemented method of claim 3, wherein the data model is a field operation data model for the agricultural task.

5. The computer-implemented method claim 4, wherein the event type is a completion event.

6. The computer-implemented method of claim 3, wherein the command identifying a change in an agricultural task includes an organizational identification and wherein the organizational identification is included as a filter parameter of the query.

7. The computer-implemented method of claim 1, further comprising:
presenting a workflow creation user interface element on a client device including:
a model selection user interface element configured to receive a selection of a model from a set of data models
an event type selection user interface element configured to receive a selection of an event type from a set of event types for the selected data model;
a conditional input element configured to receive an evaluation expression associated with a parameter of the selected event type; and
an action input element configured to receive an action to perform when the evaluation expression is true;
receiving a data package including an identification of the model, an identification of the event type, the evaluation expression, and the action;
in response to receiving the data package, generating a workflow data structure based on the identification of the model, the identification of the event type, the evaluation expression, and the action;
storing the workflow data structure in the workflow datastore.

8. A non-transitory computer-readable storage medium, the computer-readable storage medium including instructions that when executed by a processor, cause the processor to perform operations comprising:
receiving, over an API, a command identifying a change in an agricultural task;
converting, using a processing unit, the command into an event;
based on an event type of the event, retrieving a subset of workflows from a workflow datastore;
electronically evaluating conditional expressions in the subset of workflows using data of the event; and
based on the evaluating, determining a conditional expression of a workflow of the subset of workflows evaluates to true; and
in response to the determining, electronically issuing a command using the API in accordance with an action of the workflow of the subset of workflows.

9. The non-transitory computer-readable medium of claim 8, wherein the event type is defined as part of a data model of a set of data models.

10. The non-transitory computer-readable medium of claim 9, wherein retrieving the subset of workflows from a workflow datastore includes:
generating a query using the data model and event type as filter parameters and the workflow datastore as a target;
executing the query; and
receiving identifications of the subset of workflows as a result of executing the query.

11. The non-transitory computer-readable medium of claim 10, wherein the data model is a field operation data model for the agricultural task.

12. The non-transitory computer-readable medium of claim 11, wherein the event type is a completion event.

13. The non-transitory computer-readable medium of claim 10, wherein the command identifying a change in an agricultural task includes an organizational identification and wherein the organizational identification is included as a filter parameter of the query.

14. The non-transitory computer-readable medium of claim 8, wherein the instructions further configure the processor to perform operations comprising:
presenting a workflow creation user interface element on a client device including:
a model selection user interface element configured to receive a selection of a model from a set of data models an event type selection user interface element configured to receive a selection of an event type from a set of event types for the selected data model;
a conditional input element configured to receive an evaluation expression associated with a parameter of the selected event type; and
an action input element configured to receive an action to perform when the evaluation expression is true;
receiving a data package including an identification of the model, an identification of the event type, the evaluation expression, and the action;
in response to receiving the data package, generating a workflow data structure based on the identification of the model, the identification of the event type, the evaluation expression, and the action;
storing the workflow data structure in the workflow datastore.

15. A system comprising:
a processing unit;
a storage device comprising instructions, which when executed by the processing unit, configure the processing unit to perform operations comprising:
receiving, over an API, a command identifying a change in an agricultural task;
converting, using a processing unit, the command into an event;
based on an event type of the event, retrieving a subset of workflows from a workflow datastore;
electronically evaluating conditional expressions in the subset of workflows using data of the event; and
based on the evaluating, determining a conditional expression of a workflow of the subset of workflows evaluates to true; and
in response to the determining, electronically issuing a command using the API in accordance with an action of the workflow of the subset of workflows.

16. The system of claim 15, wherein the event type is defined as part of a data model of a set of data models.

17. The system of claim 16, wherein retrieving the subset of workflows from a workflow datastore includes:
generating a query using the data model and event type as filter parameters and the workflow datastore as a target;
executing the query; and
receiving identifications of the subset of workflows as a result of executing the query.

18. The system of claim 17, wherein the data model is a field operation data model for the agricultural task.

19. The system of claim 18, wherein the event type is a completion event.

20. The system of claim 17, wherein the command identifying a change in an agricultural task includes an organizational identification and wherein the organizational identification is included as a filter parameter of the query.
